(19) United States
(12) Patent Application Publication
(10) Pub. No.: US 2006/0019003 A1
(43) Pub. Date: Jan. 26, 2006

(54) Novel synergistic rapid-sanitization method

(76) Inventors: Kyokurin Take (Xulin Sun), Ibaraki (JP); Lia Skhirtladze, Ibaraki (JP)

Correspondence Address: AIR LIQUIDE, 2700 POST OAK BOULEVARD, SUITE 1800, HOUSTON, TX, 77056, US

(21) Appl. No.: 11/066,088

(22) Filed: Feb. 25, 2005

Related U.S. Application Data
(60) Provisional application No. 60/590,712, filed on Jul. 23, 2004.

(51) Int. Cl. A23L 3/3463

(52) U.S. Cl. 426/335

(57) ABSTRACT

This disclosure discusses sanitizing objects using a combination of an antimicrobial treatment and a quick freeze step. The use of antimicrobial agents for disinfecting food products often raises food quality and safety issues. The present invention uses hurdle technology to disable target microorganisms by using an antimicrobial agent, such as ozone, to make the targeted microorganisms more susceptible to the stresses of a rapid-freeze process and to lower the microbial resistance to freezing in general. Thus, it is more difficult for microorganisms to recover and reactivate during a subsequent thawing process. Hurdle technology allows low-levels of anti-microbial agents to be used to enable the use of rapid freezing for preserving foods. Novel antimicrobial hurdles coupled with conventional rapid freeze processes preserves food freshness, color, and taste while providing effective sanitation of food and non-food objects.

### BACKGROUND

It is well known that chilling food products reduces bacterial growth and retards the onset of spoilage for food products, thereby increasing shelf life. In the past 20 years, it has become known that some microorganisms have been able to adapt to a period of such chilled, low growth temperatures as long as fluidity is maintained within the body of the microorganism. Processes for preserving foods in a frozen state at temperatures of about −1° F. (−18° C.) inactivates most microorganisms present in foods and thus, can extend the shelf life of certain foods for periods of up to several months. However, when these frozen foods are thawed, many microorganisms can again become active and multiply at rates comparable to that of fresh foods. It is further known that most all food spoilage processes cease at low temperatures approaching −112° F. (−80° C.), thus deep-freezing enables frozen foods to be preserved for substantially longer periods of time and possibly to be preserved indefinitely.

Cryogenic freezing is a process in which an object is cooled or frozen through heat transfer with a cryogenic fluid. Cryogenic temperatures are defined by the Cryogenic Society of America as being temperatures below −244° F. (−153° C.). Cryogenic fluids are often used as refrigerants when a rapid rate of freezing is desired. Nitrogen is frequently used as a cryogenic refrigerant because it has a normal boiling point of −320° F. (−195° C.). Liquid nitrogen is easily accessible and cost effective to operate compared to other liquefied gases. Liquid nitrogen can be used to rapidly freeze foods or chill food products to maintain their integrity and to minimize moisture loss.

The use of cryogenic fluids to freeze food products is generally referred to as “rapid freezing”. The rate of freezing greatly impacts the quality of frozen food products. A rapid freeze process is preferred to maintain a food's freshness in terms of its appearance, color, texture and taste. Rapid freezing prevents the formation of large intracellular ice crystals, which are generally detrimental to cell survival. This effect is particularly pronounced when freezing food products containing significant moisture content. In contrast, slow freezing allows the development of large ice crystals that disrupt cell structure, thus killing more bacteria than rapid freezing does. Unfortunately, the formation of large ice crystals during slow freezing also damages the integrity of the food. Thus, the major drawback in using cryogenic refrigerants to rapidly freeze food is the relatively higher survival rate of microorganisms.

The use of ozone gas has long been an effective as an independent means of eliminating microorganisms in food products and in potable drinking water. It is known that ozone, at sufficiently high concentrations, is a substance suitable for sanitizing, disinfecting, deodorizing and/or preventing bacterial growth in food products. It is also known that ozone may be delivered using a gaseous or liquid medium or a combination thereof. Moreover, it is known that ozone has to be used properly to be effective as a disinfectant when a chilling process or freezing temperatures below about −32° F. (0° C.) are involved. For example, it is known that ozone gas demonstrates little if any antimicrobial effect when introduced to frozen food products. It is believed that the ice prevents the majority of ozone from penetrating the surface of the food product, as demonstrated when storing iced fish in an ozonated environment. The use of ozone gas for treating iced fish has been shown to have no effect on the bacteria present within the flesh of the fish. Similarly, the use of ozone ice made from ozonated water has been shown to provide no benefits over ordinary clean ice for preserving fish, due in part to the tendency of any residual ozone to decay naturally within a few hours. Other scientific studies on food preservation methods have found similar results.

U.S. Pat. No. 5,783,242 discloses a method for disinfecting poultry carcasses by treatment with chilled ozonated water or ozone gas. U.S. Pat. No. 5,858,430 discloses a method for producing chilled ozone water or ozone ice, and for preserving and disinfecting food products by supplying ozone and/or hydrogen peroxide from the chilling water or ozone ice. These methods are not generally recognized by skilled artisans as methods capable of rapidly freezing food products.

U.S. Pat. No. 4,549,477 describes an apparatus for continuously sterilizing food products by treatment with ozone gas without freezing. U.S. Pat. No. 6,777,012 discloses a technique for preserving raw fish and other meat products combining ozone treatment with a smoking process.

The use of ozone and other additives for disinfecting food products often raises significant quality control and safety issues. In some of these processes significant amounts of residual ozone can persist on the food after the desired level of disinfection has been achieved. Generally, further treatment with processes known to break down this residual ozone is required. Because many processes use ozone as a stand-alone sanitizing agent, they generally consume relatively large amounts of ozone, and thus are typically not cost effective to operate. Furthermore, the addition of other chemical constituents, colorizers, stabilizers and preservatives can be toxic to humans in certain dosages and in addition, may alter the appearance, taste, texture and color of preserved food. As a result, the use of multiple techniques to maintain the qualities and characteristics of fresh food generally requires additional process steps further increasing containment, purification and maintenance costs.

Therefore, there is a need for a sanitization method that consumes relatively low amounts of antimicrobial agents, such as ozone, in a manner that is efficient, economical and safe. There is a further need for a method of sanitizing food that incorporates the rapid-freeze process. It would be further desirable if that rapid-freeze method were able to accommodate a relatively low-cost cryogenic refrigerant, such as liquid nitrogen, to affect the requisite freezing. A self-contained, self-controlled, and low maintenance processing system is also desirable.

### SUMMARY

The present invention is directed to a method for rapidly and economically sanitizing objects by combining an antimicrobial treatment and quick freezing. The synergistic rapid-sanitization method offers the advantages of using a low level of ozone, while rapidly freezing foods, which enhances the quality of frozen food in terms of the food's appearance, color, taste and texture and at the same time, is highly effective in killing pathogenic microorganisms. The present invention uses treatment with one or more antimicrobial agents, preferably, ozone, before quick freezing to damage microorganisms on the surface of an object. Quick freezing using a cryogenic fluid, preferably, liquid nitrogen, is used to rapid-freeze the object and prevent the formation of large ice crystals. The freezing time and final temperature for cryo-preservation depends on the nature and moisture content of the object of interest. Cryogenic devices known in the art can be used to provide a rate of chilling as rapid as desired. Preferably, most food products can be quick frozen to a temperature below about −1° F. (−18° C.) in 30 seconds or less, more preferably, below about −4° F. (−20° C.) and optionally between about −22° (−30° C.) to about −40° F. (−40° C.) depending on the size and composition of the product. In some embodiments, the object is held at the cryo-preservation temperatures for a period of time and then raised to the final preservation temperature. The time involved in lowering and raising the temperature is preferably, controlled to avoid thermal shock. The sanitization method is complete when the diminished regenerative capacity of targeted microorganisms reaches a predetermined threshold value measured in terms of survival, reactivity, growth or other microbial parameters evaluated after thawing. Alternately, the diminished regenerative capacity of a target microorganism can be quantified by determining the number of viable colony forming units remaining on the cryo-preserved object after thawing.

Another embodiment of the invention is directed to methods for thawing cryo-preserved foods. The thawing rate impacts cell survival. As the temperature is increased during thawing, the small ice crystals will consolidate and increase in size. Because large intracellular ice crystals are generally detrimental to cell survival, the food should be thawed gradually to prevent the reactivation and growth of microorganisms.

It is a goal of the invention to disable target microorganism(s) by using an antimicrobial agent to make the targeted microorganism(s) more susceptible to stress through a rapid-freeze process and to lower the microbial resistance to freezing in general, thus making it more difficult for microorganisms to recover and reactivate during a subsequent thawing process. A further goal of the invention is to regulate the addition of antimicrobial agents to inflict a disturbance or disruption in the cell structure. The desired effect is that damage so inflicted, creates a hurdle that the microorganisms cannot overcome when the object is rapid-chilled with a cryogenic fluid, such as liquid nitrogen.

The synergistic rapid-sanitization method offers the advantages of a rapid-freeze process for enhancing the quality of frozen food in terms of the food's appearance, color, taste and texture and at the same time, is highly effective in killing pathogenic microorganisms. Thus, the present invention results in significant cost savings over conventional sanitization processes as measured by lower material costs, such as a lower overall consumption of antimicrobial agents, and lower energy costs associated with cryogenic chilling. The combination method offers similar advantages for sanitizing non-food objects, such as surgical, medical, dental, or laboratory items, pharmaceutical instruments and equipment, hygienic surfaces, containers, tools, utensils and similar objects.

The present invention is applicable to treating food products using a dipping process, a spraying process, a vapor injection process, a moving belt conveyor process or a pelletizing process as well as other process known to one skilled in the art. Preferred embodiments provide the advantage of regulating the reactivity and amount of antimicrobial agents, such as ozone, to enable their use in preserving food products and other hygienic applications.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a flow chart of the steps for rapidly sanitizing an object.

### DESCRIPTION OF PREFERRED EMBODIMENTS

The present invention is directed to a method for rapidly and economically sanitizing objects by combining an antimicrobial treatment and quick freezing. The present invention uses hurdle technology to address the need for a companion process capable of disrupting the cell structure of target microorganisms sufficient to enable sanitization by rapid freezing by adding a pretreatment process damaging the bacteria to the extent unable to recover after thawing. The present invention offers a higher degree of sanitization and food preservation than does either process standing alone. The introduction of antimicrobial agents, such as ozone, is staged and regulated for the primary purpose of disrupting cell structure and function, which is to make microbial cells more susceptible to deactivation and destruction by a rapid freezing process. The use of antimicrobial agents, such as ozone, can also be used as sanitizing agents in the subsequent thawing process as desired. The present invention enables the use of rapid freezing for preserving foods, offering all the advantages of conventional rapid freeze process for preserving food freshness while providing novel synergistic microbial disruption characteristic of hurdle technologies in general. Thus, the present invention enhances the disinfecting properties of rapid-freezing making it more effective than conventional slow freeze methods for preserving the freshness and microbial quality of frozen foods. Furthermore, the present invention integrates a novel abbreviated antimicrobial treatment with rapid-freezing techniques. The dosage of antimicrobial agent is definite but limited to effect microbial disruption, thus using a minimum number of process steps such that the combined system is cost-effective for use in the food industry.

One major difficulty in preserving food products having significant moisture content is the formation of large ice crystals during both freezing and thawing stages. Rapid freezing prevents the formation of large ice crystals. Although the rapid freeze process is preferred to preserve a food's freshness, it is relatively ineffective for killing microorganisms as a stand-alone sanitization method. This is because rapid freezing also prevents the formation of large intracellular ice crystals that can lead to cell death due to disruption of cellular membranes. Nevertheless, most microorganisms can be sub-lethally injured or stressed by rapid freezing, which may recover in a proper environment or may be strengthened with a combination of other biostatic effects.

Through research and development, the inventors have devised a sanitization method providing effects that are additive and synergistic with a rapid freezing process. The present invention is based on the phenomenon of homeostasis as it applies to microorganisms. Complex systems must have homeostasis to maintain stability and survive. A microbial cell is a homeostatic system that maintains its structure and functions by means of regulating a multiplicity of dynamic equilibriums. The cell reacts to every disturbance in its environment so as to regain equilibrium. The cell must adapt itself to changes in its environment and evolve. If there is insufficient time to reestablish equilibrium and regenerate, the cell can be destroyed by outside forces creating biostatic effects. The addition of antimicrobial agents is one such biostatic effect capable of damaging cell structure and creating intracellular imbalances.

Hurdle technology is one concept for identifying such biostatic effects or “hurdles” that the target microorganisms are unable to overcome. Preservative factors, such as temperature, antimicrobial agents, water activity, acidity, redox potential, and others were hurdles considered in the present invention to enhance rapid-freeze sanitization. The inventors have found that the sanitizing power of the present invention relates to the presence of free radicals, oxidizers, osmotic agents and other species, such as antimicrobial agents, that function to damage cell structure and disrupt biological mechanisms. Because of their additive, and sometimes synergistic effect, individual hurdles may be set at lower intensities than would be required if only a single hurdle was used as the preservation technique.

The controlled addition of one or more antimicrobial agents at levels lower than traditionally required to kill the microorganisms creates a disturbance or disruption in microbial cell structure. The damage so inflicted creates a hurdle that the microorganisms cannot overcome when the object is subjected to rapid-freezing. This combined treatment increases the overall effectiveness overall effectiveness of the rapid-freeze process to a degree greater than would either process used separately. The term “rapid freezing” refers to the rate of chilling and is known to one skilled in the art as a rate sufficient to prevent formation of large intracellular ice crystals which are generally detrimental to cell survival. An average freezing rate is generally used to determine the performance of a freezing process and can be defined by the following formula:
w=d₀/z₀
where w=the freezing rate, expressed in centimeters/hour (cm/hr),
d₀ is the shortest distance between the product core and the product surface, and
z₀, is the time required to cool the product from 32° F. (0° C.) to 14° F. (−10° C.).

It is known to those skilled in the art that the formation of large ice crystals is also detrimental to preserving the integrity of food products because it generally results in undesirable weight loss and drying of the food product. To ensure the cell water crystallizes fast enough to produce very small ice crystals, that are ice crystals that do not damage the cell structure of microorganisms, generally requires a freezing rate greater than about 5 cm/hour.

For comparison purposes, a conventional industrial freezing unit generally provides a slow freezing rate of 0.1 to 0.5 cm/hr. Two further factors can be used to establish the optimal heat transfer rate for rapid-freezing objects: (1) composition, including density (for food products additionally include water content, sugar content, salt content); and (2) size, including surface area and volume.

The term “quick freezing” for the purpose of this invention refers to a heat transfer step that is sufficiently quick to rapid-freeze water present on or within the object of interest at an average freezing rate that is greater than 4 cm/hour, preferably, greater than or equivalent to about 5 cm/hr.

Because the present invention views microbial disinfection and rapid-freeze preservation as synergistic techniques for killing microorganisms, their combined sanitization power in terms of reducing the number of microorganisms present on a cryo-preserved food product is greater than either technique applied separately. Specifically, the survival rate of microorganisms remaining on the cryo-preserved object of the present invention is reduced beyond that of conventional rapid-freeze techniques because their regenerative capacity has been further diminished by pretreatment with antimicrobial agents.

The term “combined cryo-preservation method” refers to the addition of antimicrobial agent(s) that is definite but limited to effect microbial disruption combined with quick freezing for inhibiting the regeneration, reactivation and growth of targeted microorganisms damaged by the antimicrobial treatment step. The synergistic effect of this “combined cryo-preservation method” can be quantified in terms of a lower number of surviving cells available on the thawed product as assayed and enumerated by microbial plate count. In addition, the use of a combined cryo-preservation process can aid in the prevention of cross-contamination by lowering the freezing resistance of microorganisms, which will generally reduce the number of surviving microbial cells available for dissemination to immersion fluids and contacting surfaces. This characteristic can provide significant benefits for reducing cross-contamination in processes that use containers or tunnels for preserving food products, particularly processes that use immersion or dipping to sanitize objects.

The effective pretreatment dosage varies with the antimicrobial agent, the target microorganism, the rapid-freeze cycle and the object of interest, such as a food product. Antimicrobial agents, such as ozone, chlorine, chlorine-containing compounds, hydrogen peroxide solutions, peracetic acid solutions, peroxyacetic acid solutions, peristaltic acid solutions and oxonia solutions, can introduce stresses affecting biological structures. Depending on the dosage, the use of antimicrobial agents can be used to kill microorganisms, or weaken microorganisms to make them more susceptible to destruction by rapid freezing.

The synergistic effect of combining antimicrobial treatment and rapid-freezing techniques is measured by assessing the survival, reactivation and growth rates of target microorganisms remaining on the cryo-preserved object. Rapid-sanitization of food products generally progresses until the regenerative capacity of target microorganisms is insufficient to support growth, which can be quantified by determining the number of colony forming units per gram of cryo-preserved food after thawing. For example, the present invention is capable of reducing the population of target microorganisms present on food products consistent with guidelines published by the American Frozen Food Institute and the Food and Drug Administration.

Similarly, the critical rapid-freezing time and temperature is optimally measured from the frame of reference of a single cell. Large intracellular ice crystals are generally detrimental to cell survival. The addition of osmotic agents may increase cell stress and death. The addition of antimicrobial agents is regulated for the primary purpose of disrupting cell structure and function; that is to make microbial cells more susceptible to deactivation and destruction by a rapid freezing process. The addition of ozone in small amounts is found to be particularly detrimental to the survival and growth rates of microorganisms commonly found on food products. Preferably, the addition of ozone is regulated to deliver a predetermined dosage. Alternatively, the addition of ozone is regulated in response to measuring one or more microbial parameters. Alternately, the ozone concentration is measured. The difference between the ozone initially present in the system and the ozone measured relates to the timing of the measurement. The ozone can be introduced prior to or substantially concurrent with the quick freezing step depending on the regenerative capabilities of target microorganisms.

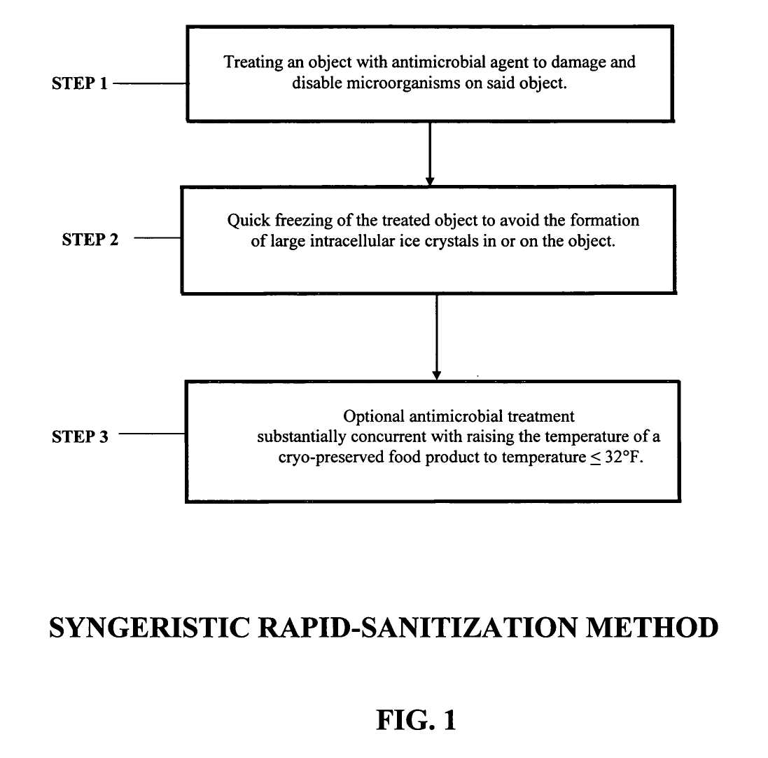

The quick freezing step can be accomplished by using a cryogenic chilling medium, such as liquid nitrogen. The rate of chilling should be sufficiently rapid to cryo-preserve the object by rapid-freezing to prevent the formation of large intracellular ice crystals. Referring to FIG. 1, during the treatment step 1, one or more antimicrobial agents are fed to a contacting device containing the object to be sanitized. Antimicrobial agents are constituents capable of damaging microbial cell structure or disrupting microbial cellular functions, such as such as ozone, chlorine, chlorine-containing compounds, hydrogen peroxide, peracetic acid, peroxyacetic acid, peristaltic acid, oxonia solutions or combinations thereof. These constituents are generated using processes known in the art. For example, processes for generating ozone gas from oxygen by either ultraviolet radiation or electrochemically are well known in the art. Preferably, ozone is generated using oxygen wherein the maximum concentration of ozone in the product stream is approximately 14 percent ozone by volume. Alternately, ozone can be generated using more traditional ambient air methods providing a typical maximum concentration of 4 percent ozone by volume.

Referring again to FIG. 1, step 1, one embodiment includes mixing one or more antimicrobial agents with a suitable substrate, such as water, comprising an antimicrobial solution having a relatively low concentration of antimicrobial agent. A preferred embodiment comprises the step of ozonating water to form a solution having an effective ozone concentration less than 0.20 milligrams of ozone per liter of water (mg/l), and even more preferably, between about 0.05 to about 0.20 mg/l. Another preferred embodiment forms a solution having an effective ozone concentration of less than about 0.10 mg/l. Yet another embodiment forms a solution having an effective ozone concentration of less than about 0.05 mg/l. These low ozone concentrations make the current process economically feasible. The generation of ozone may be accomplished using any number of devices known in the art. Alternately, oxonia solutions which are known to one skilled in the art to be a solution composed of either hydrogen peroxide and peristaltic acid, or hydrogen peroxide and peroxyacetic acid. Devices capable of feeding and controlling the delivery of antimicrobial agents or solutions thereof in accordance with the present invention are generally known to those skilled in the art.

Referring still to FIG. 1, during the treatment step 1, an amount of the antimicrobial agent introduced to the system is controlled to limit its effect to that of deactivating and disabling target microorganisms present on the object of interest. In one embodiment, the antimicrobial additive is delivered for contacting the object prior to the chilling step, preferably, by using contacting devices known in the food processing industry, such as dipping processes, spraying processes, a moving belt conveyor processes or a pelletizing process. Pelletizers are of particular application in the pharmaceutical industry for preparing medicinal or drug products under sterile conditions, such as the preparation of pelletized veterinary vaccines. In the preferred embodiment, the antimicrobial treatment is accomplished by immersing the object in an aqueous solution comprising 0.2 mg/l of ozone for a duration of 1 minute or less. Alternately, the antimicrobial additive is delivered for contacting the object during or substantially concurrent with the chilling step using vapor-phase injection or other delivery method known in the art to be suitable for use with a rapid-freeze process. Finally, other constituents may be optionally added to the mixtures of the present invention to increase solubility, increase stability or further enhance the antimicrobial activity of the solution.

In a preferred embodiment of FIG. 1, treatment step 1, the antimicrobial additive comprises ozone in aqueous solution. It is preferred that the concentration of antimicrobial agent in the feed stream not be diluted before or during the treatment step. The amount of ozone solution delivered to the object can be accurately measured and regulated with conventional control devices known in the art. Preferably, the regulation occurs by controlling the amount of ozone delivered to the object. In one embodiment, the amount of ozone is controlled by setting a concentration from about 0.05 to about 0.20 milligrams of ozone per liter of water, and controlling the duration of the treatment step. Optionally, the method of the present invention comprises the step of quantifying the ozone present in solution by measuring the ozone concentration directly; by measuring the ozone concentration indirectly, such as determined by using a spectrophotometric or colorimetric method; or by measuring the oxidation potential of the solution to correct for any dilution and/or decomposition effects occurring prior to and during treatment. For example, in preferred embodiments, the concentration of ozone in the feed stream ranges from 0.1 ppm to 0.2 ppm by weight as measured by an indigo calorimetric method, such as the Ozone AccuVac® Kit manufactured by the Hach Company. Preferably, treatment proceeds until the concentration of ozone in solution falls below the detection limit of the measurement device. Optionally, the treatment step can be repeated a number of times effective for achieving the desired sanitization effect.

Because of the relatively low solubility of ozone in aqueous solution and its highly reactive tendencies (favoring decomposition), the concentration of ozone present in the spent solution may be below standard detection limits. Thus, any excess ozonated water remaining after the treatment step can be drained away from the food product. Alternately, the ozone mixture may be freely diluted with water or other hygienic substrate to remove any residual ozone remaining on the object. Also, the residual ozone, low in concentration, will decay naturally within the chilled food

Referring again to FIG. 1, step 1, the treatment method may optionally include a step of introducing one or more antimicrobial agents directly onto the contacting surface. Alternately, the amount of antimicrobial agent can be introduced using a vapor source feeding a contacting chamber such that the amount of ozone introduced is cumulatively regulated. One embodiment further comprises monitoring one or more microbial parameters for controlled addition of antimicrobial agent in response to the diminished regenerative capacity of target microorganisms remaining on the sanitized surface. Preferably, in this embodiment, the solution is characterized by microbial activity. For example, the diminished regenerative capacity can be quantified by determining the number of viable colony forming units of one or more target microorganisms remaining on the object as defined by hygiene standards, food safety laws or other guidance documents, such as those published by the United States Food and Drug Administration or the United States Food Safety and Inspection Service. For example, the present method is capable of fully inactivating Escherichia coli bacteria initially present at a density of approximately 10⁵ colony forming units (CFU) per ml of inoculated Triptic Soy Broth sample to less than 1 CFU/3 ml Triptic Soy Broth using antimicrobial treatment with 0.2 mg/l ozone solution for less than one minute followed by rapid-freezing using liquid nitrogen. Finally, the treatment step can be performed substantially concurrent with the quick freezing step.

The invention as depicted in FIG. 1, step 2, also includes a method of quick freezing the object through heat transfer to reduce the object's temperature to about −1° F. (−18° C.) or below using a cryogenic chilling medium or equivalent. The cryogenic chilling medium generally includes, but is not limited to carbon dioxide, air, gaseous nitrogen, liquid nitrogen, liquid argon, liquid helium, liquid oxygen, liquid carbon dioxide and combinations thereof. In a preferred embodiment, the chilling medium is cryogenic liquid nitrogen. The cryogenic chilling can be carried out directly, that is, by applying liquid nitrogen directly onto the object; or indirectly, that is, by supplying the cryogenic chilling medium to a heat transfer surface such as a chamber, container, plates, pipes, or other refrigerating device known in the art, such that heat is rapidly withdrawn from the object through the heat transfer surface. Thus, the quick freezing method may be accomplished using any number of conventional cryogenic chilling processes known in the art. In a preferred embodiment, the quick freezing of the object occurs after the object has completed treatment with one or more antimicrobial agents. Alternately, the antimicrobial treatment is conducted substantially concurrent with the quick-chill step.

Referring again to FIG. 1, step 2, the rate at which the chilling step progresses is intentionally very rapid and will depend upon the nature and cross sectional thickness of the object of interest. Cryogenic control devices known in the art are employed to ensure that the rate of chilling is rapid as desired. In a preferred embodiment, the quick-chilling step is sufficiently rapid to cryo-preserve a food product, which is to rapidly freeze the food product to prevent the formation of large intracellular ice crystals which are generally detrimental to a food's appearance, color, texture, taste and nutritive value. Preferably, the average temperature of the food product entering the refrigerating device is generally in the range of about 32° F. (0° C.) to about 36° F. (2° C.). Preferably, the food product exiting the refrigerating device is at or below its freezing point at 1 atmosphere pressure. Devices suitable for carrying out cryogenic freezing processes are commercially available.

Referring again to FIG. 1, step 2, preferably, the liquid nitrogen flow is controlled to provide a temperature inside the refrigerating device of −50° F. (−45° C.) to −80° F. (−62° C.) or below, preferably, about −62° F. (−53° C.) to provide a freezing rate greater than 4 cm/hr, more preferably, equal to or greater than 5 cm/hr at the surface of the object. One embodiment involves controlling the liquid nitrogen flow to effect rapid temperature depression of an object to a setpoint temperature, preferably, about −22° F. (−30° C.) to −40° F. (−40° C.) or below, at a freezing rate equal to or greater than 0.5 cm/hr depending on the nature and thickness of the object, in 30 seconds or less. Alternatively, food products can be preserved by quick freezing at a freezing rate greater than 4 cm/hr, preferably, equal to or greater than 5 cm/hr to reduce the food temperature to about −4° F. (−20° C.) using a cryogenic chilling medium, such as liquid nitrogen, followed by further chilling by mechanical means, such as a cold air-fluidized bed or other chilled air device known in the art, to deep freeze the food product at a reduced freezing rate equal to or greater than 0.5 cm/hr, preferably, less than 4.0 cm/hr, to obtain a final setpoint temperature of about −22° F. (−30° C.) or below, more preferably, to −40° F. (−40° C.) or below. Optionally, the food product can be held at the setpoint temperature for a predetermined period of time to ensure that the temperature at the core of the food product reaches the setpoint temperature, preferably, a duration less than 24 hours. Preferably, once the frozen food product achieves its desired setpoint temperature, it is then stored at commercial storage temperatures of about −1° F. (−18° C.) or below, preferably, at −4° F. (−20° C.) or below.

Referring now to FIG. 1, step 3, another embodiment of the invention is directed to methods for thawing a cryo-preserved food product. Proper thawing and recovery is essential to maintaining the food quality achieved in steps 1 and 2. As the temperature of the food product is increased during thawing, the small ice crystals will consolidate and increase in size. Thus, there is potential for microorganisms to be reactivated or introduced to the food item during the thawing and post-thawing steps. To prevent survival, reactivation or growth of any microorganisms present on the surface of the cryo-preserved food product, the food item should be thawed as rapidly as possible at low temperatures. Optionally a two-stage thawing process comprising initial exposure at a relatively high temperature followed by rapid thawing at a low temperature is preferred for certain objects. Optionally, treatment with antimicrobial agent(s), such as ozone, can be performed substantially concurrent with raising the temperature of the frozen object.

One skilled in the art will recognize that there are various configurations for supplying antimicrobial agents, such as ozone, during the thawing process. The ozone treatments disclosed for use in the rapid-freeze process are not exclusive. The inventors anticipate that ozone may be introduced during the thawing stage and may be applied using any device and suitable carrier medium, or combination thereof, known in the art. Preferably, the carrier medium is characterized by microbial activity to control the amount of antimicrobial additives introduced. Finally, the method may optionally include the step of sanitizing the contacting container, chamber or surface using the method of the present invention prior to introducing the cryo-preserved food product. Preferably, any antimicrobial solution is hygienically drained or rinsed from the food product prior to human consumption.

Although the present invention has been described in considerable detail with reference to certain preferred versions thereof, other versions are possible. For example, the invention may include a variety of food processing devices known in the art. Furthermore, antimicrobial agents known in the art can be introduced after the chilling stage or during the thawing stage. Therefore, the spirit and scope of the appended claims should not be limited to the description of one of the preferred versions contained herein. The intention of the applicants is to cover all modifications, equivalents, and alternatives falling within the spirit and scope of the invention as defined by the appended claims.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method of rapidly sanitizing an object comprising:
a) treatment of said object with an additive comprising an antimicrobial agent, wherein said treatment step comprises the steps of:
i) introducing said antimicrobial agent to said object; and
ii) regulating the exposure of said antimicrobial agent to said object to effectively damage a microorganism on said object; and
b) quick freezing said object with a chilling medium to a temperature below about −1° F., wherein the freezing rate of said quick freezing step is greater than about 4 cm/hr, and wherein water present on the surface of said object is frozen without the formation of large intracellular ice crystals.

2. The method of claim 1, wherein said cryogenic chilling medium is liquid nitrogen.

3. The method of claim 1, wherein said cryogenic chilling medium is selected from the group consisting of:
a) carbon dioxide;
b) air;
c) gaseous nitrogen;
d) liquid nitrogen;
e) liquid argon;
f) liquid helium;
g) liquid oxygen;
h) liquid carbon dioxide; and
i) any combination thereof.

4. The method of claim 3, wherein said antimicrobial agent is selected from the group consisting of:
a) ozone;
b) chlorine;
c) chlorine-containing compounds;
d) hydrogen peroxide;
e) peracetic acid;
f) peroxyacetic acid;
g) peristaltic acid;
h) oxonia solutions; and
i) combinations thereof.

5. The method of claim 3, wherein said antimicrobial agent is ozone.

6. The method of claim 5, wherein said object is a food object.

7. The method of claim 5, wherein said additive further comprises water, and wherein said additive comprises from about 0.05 to about 0.20 milligrams of ozone per liter of water.

8. The method of claim 7, wherein said regulation occurs by controlling the amount of ozone introduced in said treatment step.

9. The method of claim 7, wherein said regulation occurs by controlling the amount of ozone introduced and a duration of said treatment step.

10. The method of claim 9, wherein said regulation further comprises a step of monitoring a microbial parameter, and wherein said microbial parameter can be correlated to the diminished regenerative capacity of said microorganism present on said object.

11. The method of claim 10, further comprising a step of deep freezing said object to a temperature at or below about −22° F., wherein the freezing rate of said deep freezing step is equal to or greater than about 0.5 cm/hr, and wherein said deep freezing step occurs after said quick freezing step.

12. The method of claim 10, further comprising a step of deep freezing said object to a temperature at or below about −40° F., wherein the freezing rate of said deep freezing step is equal to or greater than about 0.5 cm/hr, and wherein said deep freezing step occurs after said quick freezing step.

13. The method of claim 7, wherein said regulation further comprises a step of monitoring a microbial parameter, and wherein said microbial parameter can be correlated to the diminished regenerative capacity of said microorganism present on said object.

14. The method of claim 5, wherein said additive comprises less than about 0.10 milligrams of ozone per liter of water.

15. The method of claim 5, wherein said regulation occurs by controlling an amount of ozone introduced in said treatment step.

16. The method of claim 5, wherein said regulation further comprises a step of monitoring a microbial parameter, and wherein said microbial parameter can be correlated to the diminished regenerative capacity of said microorganism present on said object.

17. The method of claim 1, wherein said object is quick frozen to a temperature of about −4° F., wherein the freezing rate of said quick freezing step is greater than about 4 cm/hr, and wherein water present is frozen to prevent the formation of large intracellular ice crystals.

18. The method of claim 1, wherein said treatment occurs substantially concurrent with said quick freezing of said object.

19. The method of claim 1, further comprising a step of raising said temperature above freezing, wherein said raising temperature step occurs after said quick freezing step, and wherein the said treatment occurs substantially concurrent with said step of raising of said temperature of said object.

20. The method of claim 1, wherein said regulation comprises a step of monitoring a microbial parameter; wherein said microbial parameter can be correlated to a diminished regenerative capacity of said microorganism present on said object.

21. The method of claim 20, wherein said diminished regenerative capacity of said microorganism is quantified by determining a number of viable colony forming units of said microorganism remaining on said object.

22. The method of claim 1, further comprising the step of repeating said treatment a number of times effective for achieving the desired sanitization effect.

23. The method of claim 22, wherein said regulation occurs by controlling an amount of said antimicrobial agent introduced in said treatment step.

24. The method of claim 22, wherein said regulation further comprises a step of monitoring a microbial parameter, and wherein said microbial parameter can be correlated to the diminished regenerative capacity of said microorganism present on said object.

25. The method of claim 1, further comprising the step of repeating said treatment and said quick freezing steps a number of times effective for achieving the desired sanitization effect.

26. The method of claim 25, wherein said regulation further comprises a step of monitoring a microbial parameter, and wherein said microbial parameter can be correlated to the diminished regenerative capacity of said microorganism present on said object.

27. The method of claim 1, wherein said object is quick frozen to a temperature of about −22° F., wherein the freezing rate of said quick freezing step is greater than about 4 cm/hr, and wherein water present is frozen without the formation of large intracellular ice crystals.

28. The method of claim 27, further comprising the step of repeating said treatment a number of times effective for achieving the desired sanitization effect.

29. The method of claim 28, wherein said regulation occurs by controlling an amount of said antimicrobial agent introduced in said treatment step.

30. The method of claim 28, wherein said additive comprises water and ozone from about 0.05 to about 0.20 milligrams of ozone per liter of water, and wherein said regulation occurs by controlling the duration of said treatment step.

31. The method of claim 28, wherein said regulation further comprises a step of monitoring a microbial parameter, and wherein said microbial parameter can be correlated to the diminished regenerative capacity of said microorganism present on said object.

32. The method of claim 1, wherein said object is quick frozen to a temperature of about −40° F., wherein the freezing rate of said quick freezing step is greater than about 4 cm/hr, and wherein water present is frozen to prevent the formation of large intracellular ice crystals.

33. The method of claim 32, further comprising the step of repeating said treatment a number of times effective for achieving the desired sanitization effect.

34. The method of claim 33, wherein said regulation occurs by controlling an amount of said antimicrobial agent introduced in said treatment step.

35. The method of claim 33, wherein said additive comprises water and ozone from about 0.05 to about 0.20 milligrams of ozone in each liter of water, and wherein said regulation occurs by controlling the duration of said treatment step.

36. The method of claim 35, wherein said regulation further comprises a step of monitoring a microbial parameter, and wherein said microbial parameter can be correlated to the diminished regenerative capacity of said microorganism present on said object.
